(19) United States
(12) Patent Application Publication
(10) Pub. No.: US 2013/0101779 A1
(43) Pub. Date: Apr. 25, 2013

(54) VACUUM INSULATION MATERIAL

(71) Applicants: Jaehyun Soh, Gyeongnam (KR); Ilseob Yoon, Gyeongnam (KR); Youngbae Kim, Gyeongnam (KR)

(72) Inventors: Jaehyun Soh, Gyeongnam (KR); Ilseob Yoon, Gyeongnam (KR); Youngbae Kim, Gyeongnam (KR)

(73) Assignee: LG ELECTRONICS INC., Seoul (KR)

(21) Appl. No.: 13/805,253

(22) PCT Filed: Aug. 19, 2011
(86) PCT No.: PCT/KR2011/006131

§ 371 Date: Dec. 18, 2012

(30) Foreign Application Priority Data
Aug. 23, 2010 (KR) 10-2010-0081672
Sep. 29, 2010 (KR) 10-2010-0094788
Sep. 29, 2010 (KR) 10-2010-0094789

(51) Int. Cl. B32B 3/02

(52) U.S. Cl. CPC B32B 3/02
USPC 428/69

(57) ABSTRACT

A vacuum insulation material includes a core material, and a wrapping member configured to wrap the core material, wherein the wrapping member comprises an outermost layer externally exposed, a barrier layer located beneath the outermost layer and having at least two laminated polymer layers, each polymer layer having an inorganic layer metalized thereon, and a thermal bonding layer located beneath the barrier layer and contacting the core material, wherein the inorganic layers metalized on the polymer layers, respectively, are separated from each other, at least one of the inorganic layers being more than 600 Å in thickness.

### TECHNICAL FIELD

The present disclosure relates to a vacuum insulation material for a refrigerator, and more particularly, a vacuum insulation material having an excellent insulation characteristic, less affected by heat bridge, which may be generated at bonded portions at edges of the vacuum insulation material, by optimizing material and structure of a wrapping member of the vacuum insulation material.

### BACKGROUND ART

In general, a refrigerator is an apparatus for storing foods at low temperature, and includes a cabinet defining storage spaces, such as a refrigerating chamber, a freezing chamber or the like for storing foods, doors for opening or closing the refrigerating chamber and the freezing chamber, and a machine part having a refrigerant compression cycle.

Here, the cabinet, referring to FIG. 1, is generally configured such that an insulation material is filled between an outer surface 10 defining its appearance and an inner surface 20 defining the storage spaces to enhance cooling efficiency. To this end, a polyurethane foam 30 is injected and foamed between the inner surface 20 and the outer surface 10 in an assembled state as shown in FIG. 2.

The polyurethane foam 30 contains air therein, which causes limitation in view of improving its insulation efficiency. Hence, referring to FIG. 3, an insulation structure having an improved insulation function is employed. Namely, a vacuum insulation material 40 as well as the portion formed by the polyurethane foam 30 are employed between the outer surface 10 and the inner surface 20 of the cabinet. In other words, the polyurethane foam and the vacuum insulation material are positioned sequentially from the inner surface.

The vacuum insulation material is shown in FIG. 4. As shown in FIG. 4, the vacuum insulation material 40 includes a core material 41 formed by laminating panels formed of glass fibers and silica, and present in a vacuum state, and a wrapping member 42 for wrapping the core material 41 to maintain the vacuum state of the core material 41. In the meantime, when the core material 41 is formed of glass fibers, getters 43 is often included in the wrapping member 42 to remove gas components introduced into the wrapping member 42. Here the getter is not required when the silica is used as the core material 41.

The wrapping member 42 is a constituting element in a shape of envelope, which is formed by laminating various materials, and accommodates the core material 41 therein. In general, referring to FIG. 5, the wrapping member 42 has a structure of interposing an aluminum foil 42b between polymer films 42a and 42c to prevent permeation of humidity and gas.

After accommodating the core material 41 therein, the edge portions 44 of the wrapping member 42 are thermally bonded such that the inside of the wrapping member 42 is maintained in a vacuum state, and the bonded portions are folded. In this structure, if the aluminum foil is present in the center of the wrapping member 42, the insulation may be achieved by the core material 41. However, the core material 41 is not present at the folded portions after bonded, heat transfer by the aluminum foil cannot happen. That is, upon use of the aluminum foil in the wrapping member, since the aluminum foil is metallic, the insulation effect is less than that at the portion where the core material is present, thereby causing heat bridge that heat is transferred internally.

### DISCLOSURE OF INVENTION

### Technical Problem

Therefore, to obviate those technical problems, an aspect of the detailed description is to provide a vacuum insulation material capable of improving insulation efficiencies of edge portions of the vacuum insulation material where heat bridge is caused, and simultaneously maintaining the insulation efficiency at a portion where a core material is present.

Another aspect of this specification is to provide a vacuum insulation material having excellent insulation efficiency by virtue of an improved insulation characteristic at edge portions of the vacuum insulation material, at which heat bridge is caused, even with aluminum foil used.

### Solution to Problem

To achieve these and other advantages and in accordance with the purpose of the present invention, a vacuum insulation material in accordance with a first exemplary embodiment may include a core material, and a wrapping member configured to wrap the core material, wherein the wrapping member may include an outermost layer externally exposed, a barrier layer located beneath the outermost layer and having at least two laminated polymer layers, each polymer layer having an inorganic layer metalized thereon, and a thermal bonding layer located beneath the barrier layer and contacting the core material, wherein the inorganic layers metalized on the polymer layers, respectively, are separated from each other, at least one of the inorganic layers being more than 600 Å in thickness.

Each of the inorganic layers may be configured to have an oxygen transmission rate (OTR) less than 1.5 cc/m²·atm·day, which is measured under ASTM D3958 condition using 760 mmHg (1 atm) of 100% oxygen at one side and 760 mmHg (1 atm) of 100% nitrogen at the other side at temperature of 23° C. and 50% relative humidity.

The inorganic layers may be formed by vacuum-Al metalizing.

With the configuration, a plurality of metalized inorganic layers may be laminated between the outermost layer and the thermal bonding layer of the wrapping member to allow for sufficient insulation and humidity shielding even without use of aluminum foil, and simultaneously improve insulation efficiencies at edge portions of the wrapping member so as to minimize heat bridge. The metalizing may cause a layer or film to be thinner than a coated foil so as to be vulnerable to air and moisture permeation. Therefore, at least one of the inorganic layer may be formed with a thickness more than 600 Å so as to make up for the function as a barrier layer.

Meanwhile, at least one of the polymer layers may be ethylene vinylalcohol (EVOH), and at least a polymer layer adjacent to the outermost layer may be polyester (PET).

Also, at least one of the polymer layers may be polyester (PET), and at least a polymer layer adjacent to the outermost layer may be ethylene vinylalcohol (EVOH).

The outermost layer may be made of nylon, and the thermal bonding layer may be linear low density polyethylene (LLDPE).

In accordance with a second exemplary embodiment, a vacuum insulation material may include a core material, and a wrapping member configured to wrap the core material, wherein the wrapping member includes an outermost layer externally exposed, at least two metalized films located beneath the outermost layer and having inorganic layers metalized thereon, respectively, and a thermal bonding layer located beneath the metalized films and contacting the core material, wherein the inorganic layers metalized on the polymer layers, respectively, are separated from each other, at least one of the inorganic layers being more than 600 Å in thickness.

Each of the inorganic layers may be configured to have an oxygen transmission rate (OTR) less than 1.5 cc/m²·atm·day, which is measured under ASTM D3958 condition using 760 mmHg (1 atm) of 100% oxygen at one side and 760 mmHg (1 atm) of 100% nitrogen at the other side at temperature of 23° C. and 50% relative humidity.

Each of the metalized films may be formed by metalizing an aluminum layer on a film through vacuum-Al metalizing.

Each of the metalized films may further include an adhesive layer.

With the configuration, the employment of the metalized films each having the inorganic layer metalized thereon may facilitate relieving of heat bridge at the edge portions of the vacuum insulation material, thereby improving the insulation efficiencies at the edge portions.

In accordance with a third exemplary embodiment, a vacuum insulation material, which includes a wrapping member having a shape of envelope formed by thermally bonding outer circumferential portions of a pair of laminated films so as to accommodate a core material, similar to the configuration of the second exemplary embodiment, may further include reinforcing foils present on the laminated films excluding the bonded outer circumferential portions.

The reinforcing foil may be an aluminum foil.

With the configuration, the outer circumferential portion of the wrapping member, which is formed by the pair of laminate films, only has the laminate films each including the metalized film having the inorganic layer, without the reinforcing foil, thereby minimizing or preventing heat bridge generated at the outer circumferential portions.

Also, with the configuration, the metalized inorganic layer can be interposed between the outermost layer and the thermal bonding layer of the wrapping member to allow for sufficient insulation and moisture shielding even if partially not using an aluminum foil, and also improve insulation efficiencies at the outer circumferential portions of the wrapping member as the edge portions, thereby avoiding heat bridge.

The reinforcing foil may be coupled onto an outer surface or an inner surface of the wrapping member.

The reinforcing foil may be laminated within the laminate films.

The wrapping member may have a shape of envelope formed by thermally bonding outer circumferential portions of a pair of laminate films so as to accommodate the core material therein, wherein the wrapping member may further include a reinforcing foil disposed on an overlapped portion between the core material and the wrapping member.

In accordance with a fourth exemplary embodiment, a vacuum insulation material, which includes a wrapping member having a shape of envelope formed by thermally bonding outer circumferential portions of a pair of laminated films so as to accommodate a core material, similar to the configuration of the second exemplary embodiment, may further include reinforcing foils coupled onto the laminated films, wherein outer circumferential portions of each side surface defining edges of the envelope shape may be provided with the reinforcing foil only on a surface of one of the pair of laminate films.

With the configuration, when the outer circumferential portions of each side surface of the wrapping member are folded by predetermined intervals toward the laminate film having the reinforcing foil, the folded outer circumferential portions of each side surface may be wrapped by the laminate film only having a metalized film, on which the inorganic layer is metalized, such that the laminate film having the reinforcing foil cannot be exposed to the exterior.

According to the configuration, on the outer circumferential portions of the wrapping member defined by the pair of laminate films, one of the two laminate films forming the wrapping member may not be provided with the reinforcing foil and the laminate film without the reinforcing foil may wrap the laminate film with the reinforcing foil, thereby avoiding heat bridge generated at the outer circumferential portions as much as possible.

Upon configuring the wrapping member having such characteristic, the pair of laminate films may include a first surface defined as an upper surface and a second surface defined as a lower surface, and when the reinforcing foil is disposed only on upper and lower outer circumferential portions of the first surface on a planar surface, the reinforcing foil may be disposed only on left and right outer circumferential portions of the second surface.

Alternatively, the pair of laminate films may include a first surface defined as an upper surface and a second surface defined as a lower surface, and when the reinforcing foil is disposed only on left and right outer circumferential portions of the first surface on a planar surface, the reinforcing foil may be disposed only on upper and lower outer circumferential portions of the second surface.

### Advantageous Effects of Invention

In accordance with the detailed description, a plurality of metalized inorganic layers may be laminated between the outermost layer and the thermal bonding layer of the wrapping member to allow for sufficient insulation and humidity shielding even without use of aluminum foil, and simultaneously improve insulation efficiencies at edge portions of the wrapping member so as to minimize heat bridge.

The outer circumferential portion of the wrapping member, which is formed by the pair of laminate films, only has the laminate films each including the metalized film having the inorganic layer, without the reinforcing foil, thereby minimizing or preventing heat bridge generated at the outer circumferential portions.

Also, the metalized inorganic layer can be interposed between the outermost layer and the thermal bonding layer of the wrapping member to allow for sufficient insulation and moisture shielding even if partially not using an aluminum foil, and also improve insulation efficiencies at the outer circumferential portions of the wrapping member as the edge portions, thereby avoiding heat bridge.

In addition, on the outer circumferential portions of the wrapping member defined by the pair of laminate films, one of the two laminate films forming the wrapping member may not be provided with the reinforcing foil and the laminate film without the reinforcing foil may wrap the laminate film with the reinforcing foil, thereby avoiding heat bridge generated at the outer circumferential portions.

### BRIEF DESCRIPTION OF DRAWINGS

FIG. 1 is a perspective view of a general refrigerator;

FIGS. 2 and 3 are sectional views showing an outer wall of the general refrigerator;

FIG. 4 is a sectional view of a vacuum insulation material according to the related art;

FIG. 5 is a partial perspective view of a wrapping member according to the related art;

FIGS. 6 and 7 are partial sectional views showing a vacuum insulation material in accordance with first and second exemplary embodiments;

FIG. 8 is a schematic view showing heat transfer measurement points for the vacuum insulation material;

FIG. 9 is a graph showing comparison results of heat transfer coefficients measured at each point of FIG. 8;

FIG. 10 is a planar view of a vacuum insulation material in accordance with a third exemplary embodiment;

FIGS. 11 to 13 show different variations of the third exemplary embodiment;

FIGS. 14 and 15 are partial sectional views of the third exemplary embodiment;

FIGS. 16 and 17 are planar views showing a vacuum insulation material in accordance with a fourth exemplary embodiment; and

FIG. 18 is a planar view showing a coupled state of a wrapping member shown in FIG. 16.

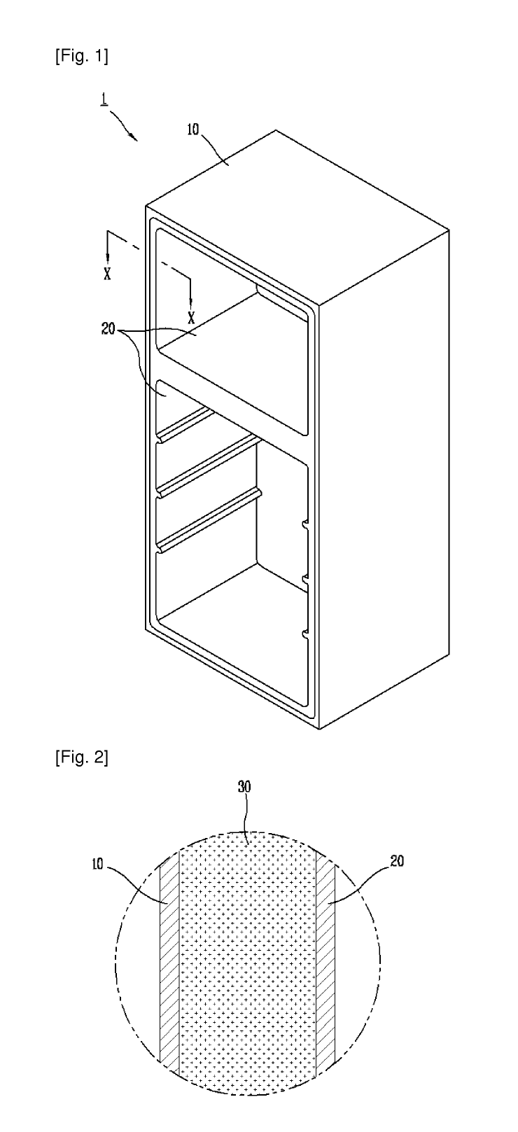

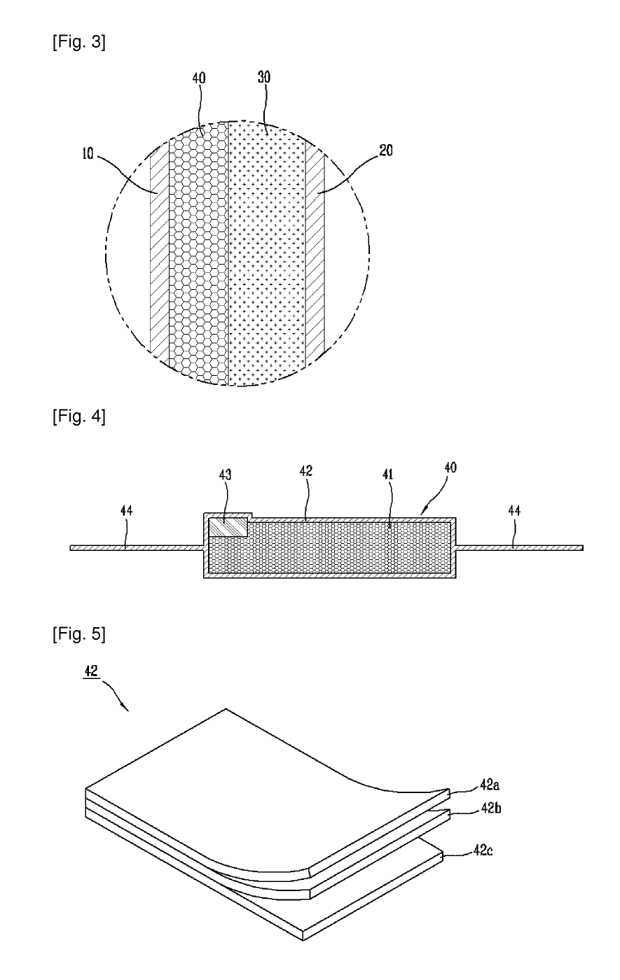

### BEST MODE FOR CARRYING OUT THE INVENTION

To achieve these and other advantages and in accordance with the purpose of the present invention, a vacuum insulation material in accordance with a first exemplary embodiment may include a core material, and a wrapping member configured to wrap the core material, wherein the wrapping member may include an outermost layer externally exposed, a barrier layer located beneath the outermost layer and having at least two laminated polymer layers, each polymer layer having an inorganic layer metalized thereon, and a thermal bonding layer located beneath the barrier layer and contacting the core material, wherein the inorganic layers metalized on the polymer layers, respectively, are separated from each other, at least one of the inorganic layers being more than 600 Å in thickness.

### MODE FOR THE INVENTION

Embodiments of the present invention will be described below in detail with reference to the accompanying drawings where those components are rendered the same reference number that are the same or are in correspondence, regardless of the figure number, and redundant explanations are omitted. In describing the present invention, if a detailed explanation for a related known function or construction is considered to unnecessarily divert the gist of the present invention, such explanation has been omitted but would be understood by those skilled in the art. The accompanying drawings are used to help easily understood the technical idea of the present invention and it should be understood that the idea of the present invention is not limited by the accompanying drawings. The idea of the present invention should be construed to extend to any alterations, equivalents and substitutes besides the accompanying drawings.

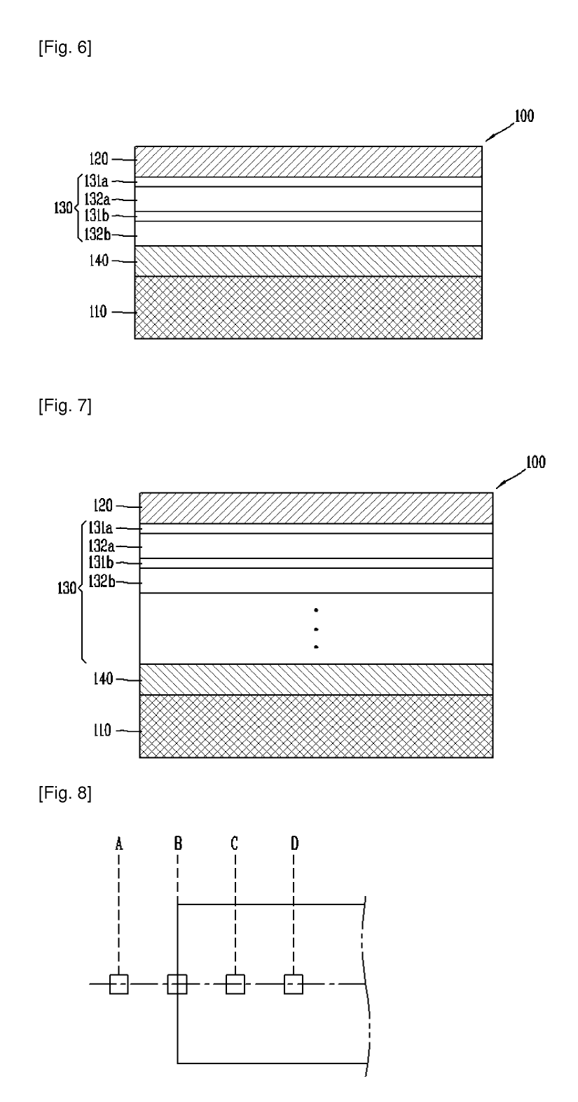

FIG. 6 shows first and second exemplary embodiments of a vacuum insulation material according to the present disclosure. As shown in FIG. 6, a vacuum insulation material according to the first exemplary embodiment may include a core material 110 and a wrapping member 100 covering the core material 110. The wrapping member may include an outermost layer 120 externally exposed, a barrier layer 130 present beneath the outermost layer 120 and formed by laminating at least two polymer layers 132a and 132b, on which inorganic layers 131a and 131b are metalized thereon, respectively, and a thermal bonding layer 140 located beneath the barrier layer 130 and contacting the core material 110.

The core material 110 may be made of glass fiber, which is well-known as a material having an excellent insulation characteristic. The core material 110 may be formed by laminating panels woven from the glass fibers so as to obtain a high insulation effect. The core material 110 may alternatively employ silica. The silica is superior to the glass fiber in the aspect of long-term reliability, by virtue of less change in performance even after extended use.

The wrapping member 100 may include the outermost layer 120, the barrier layer 130 and the thermal bonding layer 140. The wrapping member 100 may maintain a vacuum state of the core material 110 and function to protect the core material 110.

The outermost layer 120 may be formed to be exposed to an outer surface of the vacuum insulation material. In this specification, the outermost layer 120 may be formed of nylon. The nylon is a material having high elasticity, accordingly, use of the nylon may prevent the vacuum insulation material from being destroyed even due to an external impact, which may be generated during assembly or installation of the vacuum insulation material. Especially, in regard of the fact that the vacuum insulation material for a refrigerator is fabricated with a considerable size for improving efficiency, it may be possible to prevent in advance the vacuum insulation material from being defective during work or destroyed or damaged due to an external impact or scratch, by virtue of the outermost layer 120 formed of nylon.

The thermal bonding layer 140 is a portion where edge portions of the wrapping member 100 without the core material 110 are thermally bonded after accommodating the core material 110 therein to shield the inside of the wrapping member 100.

The thermal bonding layer 140 may be made of linear low density polyethylene (LLDPE). The LLDPE may be medium-pressure polyethylene or low-pressure polyethylene. Its molecular structure is similar to high density polyethylene and its density is similar to low density polyethylene, generally 0.915 to 0.965. Upon employing such LLDPE in the thermal bonding layer 140, the LLDPE exhibits relatively high melt viscosity, and rigidity or environmental stress crack resistance and tear strength about twice higher than those of the low-density polyethylene, so it may be suitable to form the thermal bonding layer 140.

Meanwhile, the barrier layer 130 may be formed between the outermost layer 120 and the thermal bonding layer 140. The barrier layer 130 may be constructed by laminating at least two polymer layers 132a and 132b, which have inorganic layers 131a and 131b metalized thereon, respectively.

In particular, the inorganic layers 131a and 131b may be separated from each other due to being metalized on the respective polymer layers 132a and 132b. Upon employing metallization, the metalized inorganic layers 131a and 131b may be thinner than a coated foil, accordingly, it may be vulnerable to permeation of air and moisture. Hence, at least one of the metalized inorganic layers 131a and 131b may be more than 600 in thickness, so as to make up for the function as a barrier layer.

In the meantime, in the first exemplary embodiment, oxygen transmission rate (OTR) should satisfy a predetermined standard under a minimal standard for the wrapping member of the vacuum insulation material. The OTR refers to a value measured on the basis of ASTM D3958 condition. That is, the inorganic layers are configured to have the OTR less than 1.5 cc/m²·atm·day, which is measured under ASTM D3958 condition using 760 mmHg (1 atm) of 100% oxygen at one side and 760 mmHg (1 atm) of 100% nitrogen at the other side at temperature of 23° C. and 50% relative humidity.

The inorganic layers 131a and 131b may be made of aluminum, and metalized on the polymer layers 132a and 132b, respectively, to be separated from each other. Therefore, at least one polymer layer may be interposed between the inorganic layers 131a and 131b. The metalizing may be implemented by metalizing aluminum on the polymer layer through vacuum-Al metalizing.

From the perspective of the configuration, a plurality of metalized inorganic layers may be laminated between the outermost layer and the thermal bonding layer of the wrapping member to allow for sufficient insulation and humidity shielding even without use of aluminum foil. That is, a plurality of thin films each having aluminum laminated thereon, other than the aluminum foil, may be used to allow for insulation and shielding. Accordingly, the metallization of the inorganic layers in form of thin film may decrease heat bridge at edge portions of the vacuum insulation material, caused due to use of a thick metal such as the aluminum foil, thereby improving insulation efficiencies the edge portions. Also, insulation and shielding effects may also be achieved even at the central portion of the vacuum insulation material which should be insulated.

FIG. 6 shows the example that two polymer layers stacked each other. Referring to FIG. 6, the inorganic layers 131a and 131b are metalized on the polymer layers 132a and 132b, respectively.

The polymer layers 132a and 132b may be made of ethylene vinylalcohol (EVOH) or polyester (PET). Since the EVOH has an alcohol group with strong polarity, it has a high intermolecular force and accordingly can have low oxygen permeability. However, the EVOH is hydrophilic, thus it is sensitive to water. Therefore, this exemplary embodiment may use the EVOH together with the PET. The PET has a relatively good permeability. Also, the PET is excellent in view of moisture vapor permeability and relative cheap cost, compared to the EVOH.

The polymer layers 132a and 132b may be configured as follows in the aforementioned aspect. At least one of the polymer layers may be EVOH, and at least one of the polymer layers adjacent to the outermost layer may be PET. With this configuration, even when employing the EVPOH polymer layer with hydrophilicity, it may exhibit an excellent characteristic in view of moisture vapor permeability.

Also, at least one of the polymer layers may be PET, and at least one of the polymer layers contacting the thermal bonding layer may be EVOH. With the configuration, the EVOH polymer layer having an excellent characteristic in view of the oxygen transmission rate may finally form the barrier layer, thereby improving reliability for maintaining the vacuum state within the wrapping member.

FIG. 6 shows the example that one PET polymer layer 132a on which an aluminum layer is metalized is laminated on one EVOH polymer layer 132b on which aluminum layer is metalized. However, this specification may not be limited to the example, but be applicable to another example of having a plurality of polymer layers laminated one another. The another example is shown in FIG. 7.

FIG. 7 shows that two or more polymer layers are laminated one another. Here, at least one film, which contacts the thermal bonding layer, of the polymer layers, may preferably be an EVOH layer. Also, the polymer layers sequentially laminated on the EVOH layer may be PET polymer layers each having an aluminum layer metalized thereon. This structure may be beneficial in view of prevention of moisture permeation and reduction of fabrication cost.

FIG. 8 shows a test of measuring heat transfer at each point of the vacuum insulation material in a refrigerator having the vacuum insulation material. Referring to FIG. 8, a point A indicates a portion merely having polyurethane foam without the vacuum insulation material at an outer wall of a refrigerator cabinet, a point B indicates an edge portion of the vacuum insulation material, a point C indicates a portion adjacent to the edge portion of the vacuum insulation material, and a point D indicates a portion, which is not affected by heat bridge due to being spaced apart to some degree from the edge portion of the vacuum insulation portion.

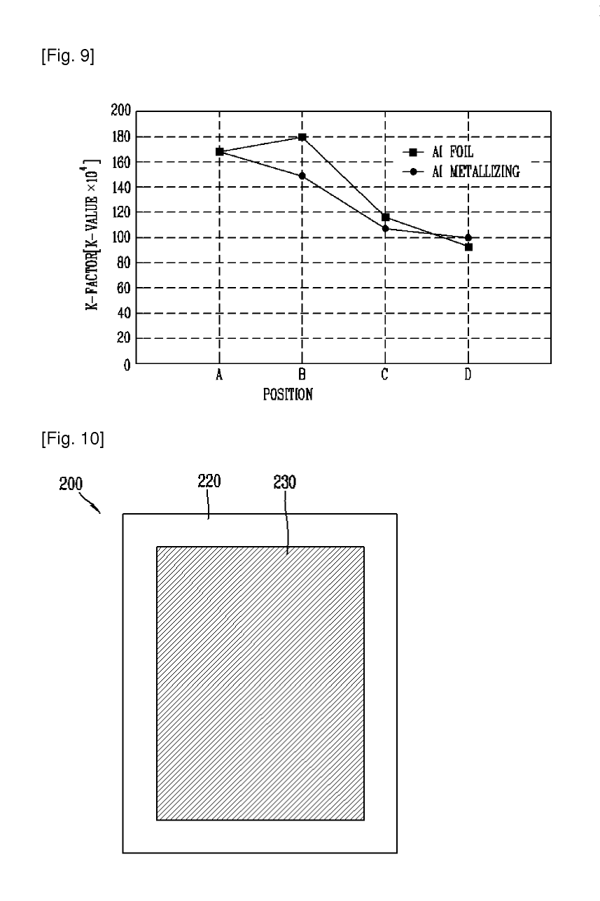

FIG. 9 shows heat transmittance each point of FIG. 8. The test has been carried out to show the amount of heat flowing by heat conductivity when applying the vacuum insulation material according to the present disclosure and the related art vacuum insulation material using the aluminum foil to a refrigerator, respectively, under a state that the inside is at low temperature and the outside is at high temperature. A value measured at each point is expressed by K-Factor(K-value*10⁴) and a unit is kcal/m·h·° C.

Referring to FIG. 9, a point A is a portion merely having the polyurethane foam, so a value of about 170 kcal/m·h·° C. is measured as a common measurement.

However, a point which is the most concentrated on in this exemplary embodiment is the point B. At the point B, the outer wall of the refrigerator cabinet has an insulation structure which includes the polyurethane foam and the vacuum insulation material. Accordingly, the transfer ratios of heat, which is transferred through the polyurethane foam and the vacuum insulation material, have been measured at the point B. Here, comparing K values when the insulation structure of the refrigerator cabinet is formed by laminating the vacuum insulation material according to the present disclosure or the related art vacuum insulation material and the polyurethane foam, K value of about 150 kcal/m·h·° C. has been measured when laminating the vacuum insulation material according to the present disclosure and the polyurethane foam, whereas K value of about 180 kcal/m·h·° C. has been measured when laminating the related art vacuum insulation material and the polyurethane foam. Therefore, it can be noticed that when employing the related art vacuum insulation material, the heat conductivity is rather increased than employing only the polyurethane foam. A considerable difference can also be found.

This is observed similarly at the point C which is affected by heat bridge to some degree. When forming an insulation structure of the refrigerator cabinet by laminating the vacuum insulation material according to the present disclosure and the polyurethane foam, K value of about 110 kcal/m·h·° C. has been measured. However, when using the related art vacuum insulation material, K value of about 120 kcal/m·h·° C. has been measured. Consequently, it can be understood that the vacuum insulation material according to the present disclosure can decrease heat bridge and obtain a high insulation effect.

Here, at the point D considerably distant from the edge portion, K value of about 100 kcal/m·h·° C. has been measured when using the vacuum insulation material according to the present invention together with the polyurethane foam, while K value of about 95 kcal/m·h·° C. has been measured when using the related art vacuum insulation material together with the polyurethane foam. This results from the high insulation effect by virtue of thickness when using the aluminum foil. Consequently, it can be noticed that there is not a great difference in view of the insulation effect even when laminating a plurality of aluminum-metalized layers.

Therefore, upon employing the vacuum insulation material according to this specification, it is excellent to prevent or minimize the heat bridge at the edge portions as much as showing a considerable difference from the related art vacuum insulation material, and its satisfactory performance is exhibited at other portions thereof in view of insulation efficiency with rare difference.

Hereinafter, description will be given of a second exemplary embodiment according to the present disclosure. Here, detailed description of the same/like components to those in the first exemplary embodiment will be omitted.

Meanwhile, a vacuum insulation material according to the second exemplary embodiment may include a core material and a wrapping member covering the core material. The wrapping member may include an outermost layer externally exposed, at least two metalized films located beneath the outermost layer and having inorganic layers metalized thereon, respectively, and a thermal bonding layer located beneath the metalized films and contacting the core material. The inorganic layers may be metalized on the metalized films, respectively, so as to be separated from each other. At least one of the inorganic layers may be more than 600 in thickness. The second exemplary embodiment is similar to the first exemplary embodiment, so it will be described with reference to FIGS. 6 to 9.

The inorganic layers are configured to have the OTR less than 1.5 cc/m²·atm·day, which is measured under ASTM D3958 condition using 760 mmHg (1 atm) of 100% oxygen at one side and 760 mmHg (1 atm) of 100% nitrogen at the other side at temperature of 23° C. and 50% relative humidity.

The metalized film may be formed by metalizing an aluminum layer on a film through vacuum-Al metalizing. It is not very different from the polymer layer having the aluminum layer metalized. Here, it is slightly different from the polymer layer in the aspect of being implemented as the metalized film. Other structure is not different from the first exemplary embodiment, so detailed description will be omitted.

At least one of the metalized films may be configured to have an inorganic layer, which is more than 600 in thickness. The metalized films may be laminated each other with bonded to each other by an adhesive. That is, an adhesive layer may further be interposed between the metalized films. This structure may be commonly applied to the polymer layer having the aluminum layer metalized thereon.

Regarding the configuration, the employment of the metalized films each having the inorganic layer metalized thereon may facilitate relieving of heat bridge at the edge portions of the vacuum insulation material, thereby improving the insulation efficiencies at the edge portions.

Hereinafter, description will be given of a third exemplary embodiment according to the present disclosure. Here, the same/like components to those in the first and second exemplary embodiments will not be described in detail.

A vacuum insulation material in accordance with the third exemplary embodiment may include a core material 250, and a wrapping member 200 for accommodating the core material 250 and having a shape of an envelope formed by thermally bonding outer circumferential portions 220 of a pair of laminate films 210 each including a metalized film, on which the inorganic layer 212 is metalized, respectively.

Description of the core material 250 has already been described, so description thereof will be omitted.

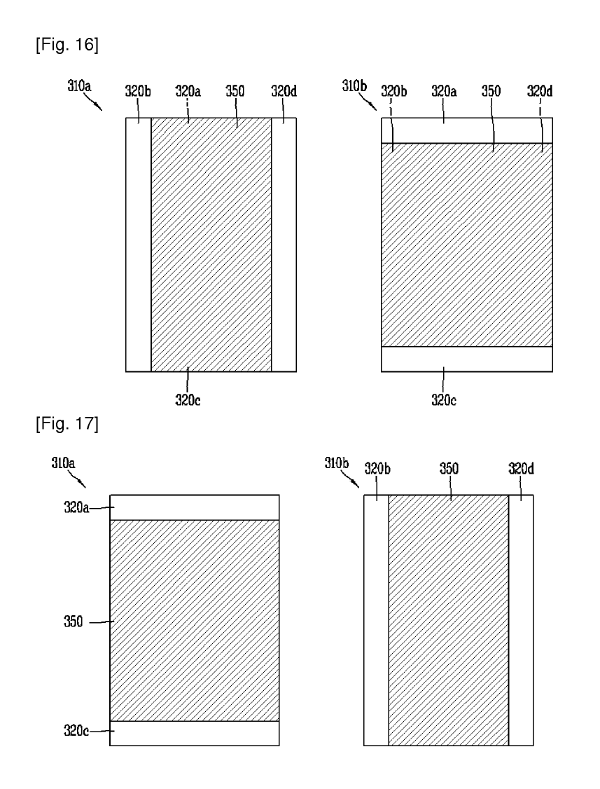

Each of the laminate films 210, as shown in FIGS. 14 and 15, may include an outermost layer 213 externally exposed, a barrier layer 215 located beneath the outermost layer 213 and having a metalized film 211 having the inorganic layer 212 metalized thereon, and a thermal bonding layer 214 located beneath the barrier layer 215 and contacting the core material 250. The laminate film 210 may maintain a vacuum state of the core material 250 and function to protect the core material 250.

The outermost layer 213, referring to FIG. 14, is a layer exposed to an outer surface of the vacuum insulation material. Here, FIG. 14 exemplarily shows that a reinforcing foil 260 is additionally bonded onto the outside of the outermost layer 213.

The outermost layer 213 may be formed to be exposed to the outer surface of the vacuum insulation material. The thermal bonding layer 214 may be a layer of shielding the inside of the wrapping member 200, in which the core material 250 is accommodated, by thermally bonding outer circumferential portions of the wrapping member 200 where the core material 250 is not located. The outermost layer and the thermal bonding layer are the same as those described in the first exemplary embodiment, so detailed description thereof will be omitted.

In the meantime, the barrier layer 215 may be interposed between the outermost layer 213 and the thermal bonding layer 214. The barrier layer 215 may include a metalized film 211, on which the inorganic layer 212 is metalized. The inorganic layer 212 may be laminated by metalizing aluminum on a polymer film through vacuum-Al metalizing.

Regarding the configuration, the metalized inorganic layer can be interposed between the outermost layer and the thermal bonding layer of the laminate film to allow for sufficient insulation and moisture shielding even if partially not using the aluminum foil, and also improve insulation efficiencies the outer circumferential portions of the laminate films as the edge portions of the wrapping member, thereby avoiding heat bridge.

The polymer film may be made of ethylene vinylalcohol (EVOH) or polyester (PET). Since the EVOH has an alcohol group with strong polarity, it has a high intermolecular force and accordingly can have low oxygen permeability. However, the EVOH is hydrophilic, thus it is sensitive to water. The PET has a relatively good permeability. Also, the PET is excellent in view of moisture vapor permeability and relatively cheap cost, compared to the EVOH.

In this exemplary embodiment, the laminate film may be configured by including two or more metalized films each having an inorganic layer metalized thereon. However, this specification may not be limited to the structure. Alternatively, a plurality of polymer films may be laminated one another. This structure may allow the vacuum insulation material to be designed suitable for desired water vapor permeability and air permeability.

The wrapping member 200 according to the third exemplary embodiment may further include a reinforcing foil on an area 230 excluding the thermally bonded outer circumferential portion 220. FIG. 10 shows one surface of a pair of laminate films, which form the wrapping member in the shape of envelope. FIG. 10 shows that the outer circumferential portion 220 of the laminate film defines all the side surfaces of the envelope shape, and the central area 230 surrounded by the outer circumferential portion 220 is shown to be distinguishable from the outer circumferential portion 220.

The outer circumferential portion 220 may be formed at each of the pair of laminate films defining both surfaces 210a and 210b of the wrapping member 200 in the shape of envelope. An outer circumferential portion of one surface may be thermally bonded to an outer circumferential portion of the other surface into the shape of envelope so as to seal the wrapping member.

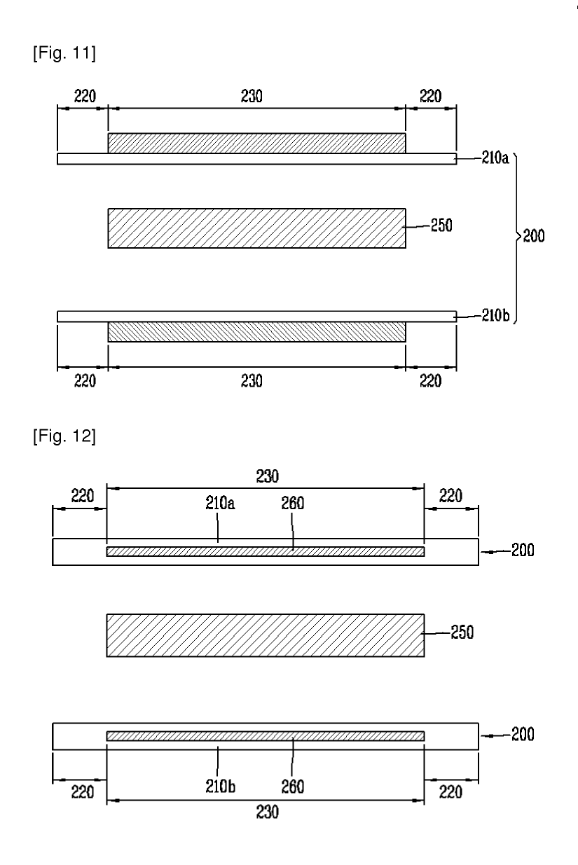

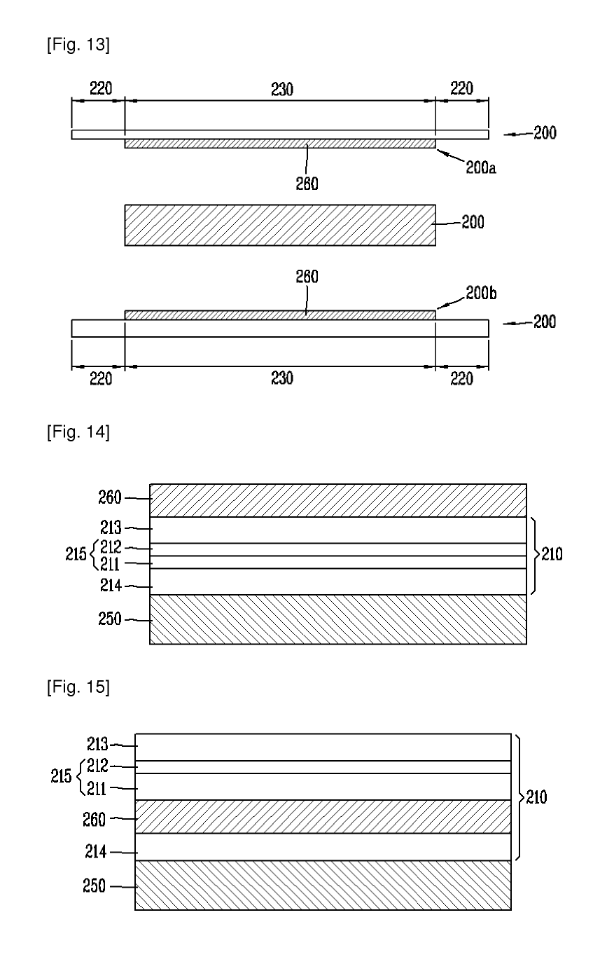

Here, the reinforcing foil may be an aluminum foil. FIGS. 11 to 13 show variations having such reinforcing foil. The variation shown in FIG. 11 shows that the reinforcing foil is bonded onto the outer surface of the wrapping member. The variation shown in FIG. 12 shows that the reinforcing foil is located inside the laminate film or interposed between the outermost layer and the thermal bonding layer, and FIG. 13 shows that the reinforcing foil is bonded onto an inner surface of the wrapping member.

In more detail, referring to FIGS. 11 to 13, the reinforcing foil 260 is disposed only on the central area 230 surrounded by the outer circumferential portion 220. Here, the core material 250 may be located within the wrapping member 200 corresponding to the central area 230. Accordingly, the outer circumferential portion 220 of the wrapping member 200, which is formed by the pair of laminate films, only has the laminate films each including the metalized film having the inorganic layer, without the reinforcing foil. Therefore, the central area 230 where the core material 250 is located can exhibit an excellent insulation efficiency by virtue of existence of the reinforcing foils, which are laminated on the respective upper and lower laminate films. Also, the outer circumferential portion 220 may be allowed to prevent heat bridge, which is generally generated at the outer circumferential portion, by virtue of non-existence of the reinforcing foil.

Meanwhile, the vacuum insulation material according to this exemplary embodiment may include a core material, and a wrapping member having a shape of envelope formed by bonding outer circumferential portions of a pair of laminate films, each of which includes a metalized film having an inorganic layer metalized thereon, and accommodating the core material therein. The wrapping member may further include a reinforcing foil located at an overlapped portion between the core material and the wrapping member. With this configuration, the reinforcing foils are present in an overlapped state on both surfaces of the central area 230, which correspond to the overlapped portion between the core material and the wrapping member, thereby obtaining excellent insulation efficiency. Also, the reinforcing foil is not prevent at the outer circumferential portion 220, so the vacuum insulation material exhibits an excellent characteristic in view of preventing heat bridge.

Hereinafter, description will be given of a fourth exemplary embodiment according to the present disclosure. Here, the same/like components to those in the first and second exemplary embodiments will not be described in detail.

A vacuum insulation material according to the fourth exemplary embodiment may include a core material, and a wrapping member 300 having a shape of envelope as shown in FIG. 18, formed by thermally bonding outer circumferential portions 320 of a pair of laminate films 310 each having a metalized film 311, on which an inorganic layer 312 is metalized, and accommodating the core material therein.

The detailed description of the core material, which has been explained, will be omitted.

Meanwhile, the laminate films 310 schematically have similar sections to the laminate films of the wrapping member shown in FIGS. 14 and 15 of the third exemplary embodiment, so they will be described with reference to the third exemplary embodiment. Each of the laminate films 310 may include an outermost layer 313 externally exposed, a barrier layer 315 located beneath the outermost layer 313 and having a metalized film 311, on which an inorganic layer 312 is metalized, and a thermal bonding layer 314 located beneath the barrier layer 315 and contacting the core material.

The outermost layer 313 may be formed to be exposed to the outer surface of the vacuum insulation material. The thermal bonding layer 314 is a layer of shielding the inside of the wrapping member, in which the core material is accommodated, by thermally bonding an outer circumferential portion of the wrapping member 300 where the core material is not located. The outermost layer and the thermal bonding layer are the same as those described in the first exemplary embodiment, so detailed description thereof will be omitted.

In the meantime, a barrier layer 315 may be interposed between the outermost layer 313 and the thermal bonding layer 314. The barrier layer 315 may include a metalized film 311, on which the inorganic layer 312 is metalized. The inorganic layer 312 may be laminated by metalizing aluminum on a polymer film through vacuum-Al metalizing.

With the configuration, the metalized inorganic layer can be laminated between the outermost layer and the thermal bonding layer of the laminate film to allow for sufficient insulation and moisture shielding even if partially not using the aluminum foil, and simultaneously improve insulation efficiency at the outer circumferential portion of the laminate film as the edge portion of the wrapping member, thereby avoiding heat bridge.

Detailed description of the polymer film is similar to that of the third exemplary embodiment, so it will not be repeated.

In this exemplary embodiment, the laminate film may include, but not limited to, two or more metalized films each having the inorganic layer metalized. Alternatively, the laminate film may include a plurality of polymer films laminated one another. This structure may allow the vacuum insulation material to be designed suitable for desired water vapor permeability and air permeability.

The wrapping member 300, in the meantime, may further include a reinforcing foil 350 coupled to each of the laminate films. Here, outer circumferential portions 320a, 320b, 320c and 320d of the wrapping member 300 may be provided with a reinforcing foil 350 only on a surface of one of the pair of laminate films 310a and 310b.

Here, the reinforcing foil 350 may be an aluminum foil. The reinforcing foil 350 may be coupled onto an outer surface of the wrapping member, laminated inside the wrapping member, coupled onto an outer surface of the outermost layer, or interposed between the outermost layer and the thermal bonding layer.

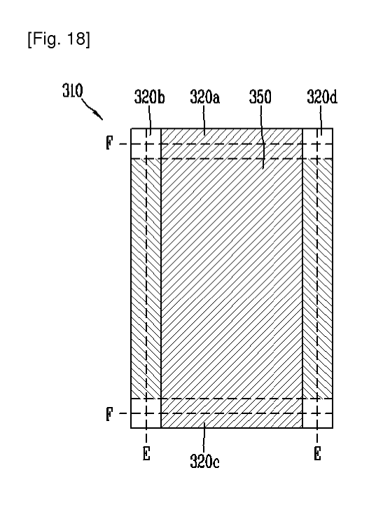

FIGS. 16 and 17 show that the reinforcing foil is disposed on a plane, which show in more detail the configuration that outer circumferential portions of the wrapping member may be provided with a reinforcing foil only on a surface of one of the pair of laminate films.

As one example, referring to FIG. 16, the pair of laminate films may include a first surface 310a defined as an upper surface and a second surface 310b defined as a lower surface. On the same planar surface, when the reinforcing foil 350 is disposed on an upper outer circumferential portion 320a and a lower outer circumferential portion 320c of the first surface 310a, the reinforcing foil 350 may be disposed only on a left outer circumferential portion 320b and a right outer circumferential portion 320d of the second surface 310b.

More especially, regarding the laminate films defining both surfaces of the wrapping member in the shape of envelope, referring to FIG. 16, the outer circumferential portions 320a, 320b, 320c and 320d are formed in the order of a counterclockwise direction to be bonded to outer circumferential portions of the other surface through thermal bonding, thereby sealing the wrapping member in the shape of envelope.

In FIG. 16, on the first surface 310a corresponding to the upper surface of the outer circumferential portions defining each side surface of the envelope shape, the outer circumferential portions 320a and 320c corresponding to the upper side surface and the lower side surface are reinforced by the reinforcing foil 350. However, the outer circumferential portions 320b and 320d corresponding to the left and right side surfaces are not provided with the reinforcing foil 350. Also, on the second surface 310b corresponding to the lower surface, the outer circumferential portions 320b and 320d corresponding to the left and right side surfaces are reinforced by the reinforcing foil 350 but the outer circumferential portions 320a and 320c corresponding to the upper and lower side surfaces are not provided with the reinforcing foil 350.

In accordance with this exemplary embodiment, when completely forming the envelope shape by thermally bonding the upper and lower surfaces, an envelope in the shape shown in FIG. 18 is obtained. Referring to FIG. 18, both surfaces of the central area surrounded by the outer circumferential portions are reinforced by the reinforcing foils 350. However, regarding the outer circumferential portions 320a, 320b, 320c and 320d defining each side surface of the envelope shape, the reinforcing foil is not present on any of both surfaces, and only one surface or none is provided with the reinforcing foil.

In general, upon employing the vacuum insulation material in a refrigerator, outer circumferential portions may be folded by a predetermined interval, so as to facilitate mounting of the vacuum insulation material, which may however cause heat bridge. However, with the configurations of the exemplary embodiments, when the outer circumferential portion of each side surface is folded by a predetermined interval toward the laminate film having the reinforcing foil, the laminate films having the reinforcing foils may not be exposed to the exterior by virtue of the respectively folded outer circumferential portions 320a, 320b, 320c and 320d of the side surfaces.

Also, an outer circumferential portion having the reinforcing foil at only one surface may be wrapped by the other surface without the reinforcing foil. That is, the upper and lower outer circumferential portions, referring to FIG. 18, are folded toward the laminate film (i.e., toward the first surface) having the reinforcing foil on the outer circumferential portions, namely, folded in an outgoing direction based on line F on the planar surface. In addition, still referring to FIG. 18, the left and right outer circumferential portions are folded toward the laminate film (i.e., toward the second surface) having the reinforcing foil on the outer circumferential portions, namely, folded in an incoming direction based on line E on the planar surface. Consequently, the outside of at least the folded portions of the laminate film having the reinforcing foil may all be wrapped by the laminate film without the reinforcing foil.

According to the configuration, on the outer circumferential portions of the wrapping member defined by the pair of laminate films, one of the two laminate films forming the wrapping member is not provided with the reinforcing foil and the laminate film without the reinforcing foil wraps the laminate film with the reinforcing foil, thereby avoiding heat bridge generated at the outer circumferential portions as much as possible.

Another exemplary embodiment is shown in FIG. 17, referring to FIG. 17, the pair of laminate films may include a first surface 310a defined as an upper surface and a second surface 310b defined as a lower surface. On the planar surface, when the reinforcing foil 350 is disposed on a left outer circumferential portion 320b and a right outer circumferential portion 320d of the first surface 310a, the reinforcing foil 350 may be disposed only on an upper outer circumferential portion 320a and a lower outer circumferential portion 320c of the second surface 310b.

In the exemplary embodiment shown in FIG. 17, similar to FIG. 18, upon completely forming the envelope shape by thermally bonding the upper and lower surfaces, an envelope in an upsidedown shape of the envelope shown in FIG. 18 is obtained. Accordingly, both surfaces of the central area surrounded by the outer circumferential portions are reinforced by the reinforcing foils 350, but, regarding the outer circumferential portions 320a, 320b, 320c and 320d defining each side surface of the envelope shape, the reinforcing foil is not present on any of both surfaces, and only one surface or none is provided with the reinforcing foil.

Here, regarding the envelope having an upside-down shape of the envelope shown in FIG. 18, the upper and lower outer circumferential portions are folded toward the laminate film (i.e., toward the second surface) having the reinforcing foil at the outer circumferential portions, namely, folded in an incoming direction based on line F on the same level. Also, the left and right outer circumferential portions are folded toward the laminate film (i.e., toward the first surface) having the reinforcing foil at the outer circumferential portions, namely, folded in an outgoing direction based on line E on the same level. Consequently, the outside of at least the folded portions of the laminate film having the reinforcing foil may all be wrapped by the laminate film without the reinforcing foil.

According to the configuration, on the outer circumferential portions of the wrapping member defined by the pair of laminate films, one of the two laminate films forming the wrapping member is not provided with the reinforcing foil and the laminate film without the reinforcing foil wraps the laminate film with the reinforcing foil, thereby avoiding heat bridge generated at the outer circumferential portions as much as possible.

In the meantime, the fourth exemplary embodiment may not be limited to those examples. That is, although both surfaces of the central portion surrounded by the outer circumferential portions are all reinforced by the reinforcing foils, if the reinforcing foil is provided on one or none of both surfaces on the outer circumferential portions 320a, 320b, 320c and 320d defining each side surface of the envelope shape, it may be a variation of the exemplary embodiment. For example, it may be configured to form reinforcing foils on upper and left outer circumferential portions of a first surface and lower and right outer circumferential portions of a second surface. Even in this case, similar to the foregoing exemplary embodiments, the heat bridge generated at the outer circumferential portions can be avoided as much as possible and simultaneously the insulation efficiency at the central area can be excellent.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

1. A vacuum insulation material comprising:
a core material; and
a wrapping member configured to wrap the core material,
wherein the wrapping member comprises an outermost layer externally exposed, a barrier layer located beneath the outermost layer and having at least two laminated polymer layers, each polymer layer having an inorganic layer metalized thereon, and a thermal bonding layer located beneath the barrier layer and contacting the core material,
wherein the inorganic layers metalized on the polymer layers, respectively, are separated from each other, at least one of the inorganic layers being more than 600 Å in thickness.

2. The material of claim 1, wherein each of the inorganic layers is configured to have an oxygen transmission rate (OTR) less than 1.5 cc/m²·atm·day, which is measured under ASTM D3958 condition using 760 mmHg (1 atm) of 100% oxygen at one side and 760 mmHg (1 atm) of 100% nitrogen at the other side at temperature of 23° C. and 50% relative humidity.

3. The material of claim 2, wherein the inorganic layers are formed by vacuum-Al metalizing.

4. The material of claim 3, wherein at least one of the polymer layers is ethylene vinylalcohol (EVOH), and at least a polymer layer adjacent to the outermost layer is polyester (PET).

5. The material of claim 3, wherein at least one of the polymer layers is polyester (PET), and at least a polymer layer adjacent to the outermost layer is ethylene vinylalcohol (EVOH).

6. A vacuum insulation material comprising:
a core material; and
a wrapping member configured to wrap the core material,
wherein the wrapping member comprises an outermost layer externally exposed, at least two metalized films located beneath the outermost layer and having inorganic layers metalized thereon, respectively, and a thermal bonding layer located beneath the metalized films and contacting the core material,
wherein the inorganic layers metalized on the polymer layers, respectively, are separated from each other, at least one of the inorganic layers being more than 600 Å in thickness.

7. The material of claim 6, wherein each of the inorganic layers is configured to have an oxygen transmission rate (OTR) less than 1.5 cc/m²·atm·day, which is measured under ASTM D3958 condition using 760 mmHg (1 atm) of 100% oxygen at one side and 760 mmHg (1 atm) of 100% nitrogen at the other side at temperature of 23° C. and 50% relative humidity.

8. The material of claim 7, wherein each of the metalized films is formed by metalizing an aluminum layer on a film through vacuum-Al metalizing.

9. The material of claim 6, wherein each of the metalized films further comprises an adhesive layer.

10. The material of claim 1, wherein the outermost layer is nylon.

11. The material of claim 1, wherein the thermal bonding layer is linear low density polyethylene (LLDPE).

12. The material of claim 6, wherein the wrapping member has a shape of envelope formed by thermally bonding outer circumferential portions of a pair of laminate films so as to accommodate the core material therein,
wherein the wrapping member further comprises a reinforcing foil disposed on a portion where the laminate films excluding the bonded outer circumferential portions are present.

13. The material of claim 12, wherein the reinforcing foil is an aluminum foil.

14. The material of claim 12, wherein the reinforcing foil is coupled onto an outer surface or an inner surface of the wrapping member.

15. The material of claim 12, wherein the reinforcing foil is laminated within the laminate films.

16. The material of claim 6, wherein the wrapping member has a shape of envelope formed by thermally bonding outer circumferential portions of a pair of laminate films so as to accommodate the core material therein,
wherein the wrapping member further comprises a reinforcing foil disposed on an overlapped portion between the core material and the wrapping member.

17. The material of claim 6, wherein the wrapping member has a shape of envelope formed by thermally bonding outer circumferential portions of a pair of laminate films so as to accommodate the core material therein, wherein the wrapping member further comprises reinforcing foils coupled onto the laminate films,
wherein outer circumferential portions of each side surface defining edges of the envelope shape are provided with the reinforcing foil only on a surface of one of the pair of laminate films.

18. The material of claim 17, wherein when the outer circumferential portions of each side surface of the wrapping member are folded by predetermined intervals toward the laminate film having the reinforcing foil, the folded outer circumferential portions of each side surface are wrapped by the laminate film having a metalized film, on which the inorganic layer is metalized, such that the laminate film having the reinforcing foil is not exposed to the exterior.

19. The material of claim 18, wherein the pair of laminate films comprise a first surface defined as an upper surface and a second surface defined as a lower surface,
wherein when the reinforcing foil is disposed only on upper and lower outer circumferential portions of the first surface on a planar surface, the reinforcing foil is disposed only on left and right outer circumferential portions of the second surface.

20. The material of claim 18, wherein the pair of laminate films comprise a first surface defined as an upper surface and a second surface defined as a lower surface,
wherein when the reinforcing foil is disposed only on left and right outer circumferential portions of the first surface on a planar surface, the reinforcing foil is disposed only on upper and lower outer circumferential portions of the second surface.
